(19) United States
(12) Patent Application Publication
(10) Pub. No.: US 2024/0138432 A1
(43) Pub. Date: May 2, 2024

(54) PROTEIN-FORTIFIED FOOD WITH INCREASED SHELF STABILITY

(71) Applicant: Leprino Foods Company, Denver, CO (US)

(72) Inventors: Jiancai Li, Englewood, CO (US); Richard K. Merrill, Highlands Ranch, CO (US)

(73) Assignee: Leprino Foods Company, Denver, CO (US)

(21) Appl. No.: 18/497,750

(22) Filed: Oct. 30, 2023

Related U.S. Application Data
(60) Provisional application No. 63/420,803, filed on Oct. 31, 2022.

(51) Int. Cl. A23C 21/06; A23C 21/10

(52) U.S. Cl. CPC A23C 21/06; A23C 21/10

(57) ABSTRACT

Protein containing foods are described that include a protein blend having one or more milk proteins. The protein blend is also characterized by less than or about 1500 mg % of calcium. Also described are food products with increased shelf stability. The food product includes a protein blend that includes one or more milk proteins, where the protein blend includes less than or about 5 wt. % lactose. The food product is also characterized by a total protein content of greater than or about 15 wt. %. Further described are methods of making a food product that include combining a protein blend with additional ingredients to form a food mixture, and heating the food mixture to form the food product. The food product includes a total protein content of greater than or about 15 wt. %, and the protein blend includes less than or about 1500 mg % calcium.

### CROSS REFERENCE TO RELATED APPLICATION

This application claims benefit of U.S. Provisional Patent Application No. 63/420,803, entitled, “PROTEIN-FORTIFIED FOOD WITH INCREASED SHELF STABILITY”, filed on Oct. 31, 2022, the contents of which are hereby incorporated by reference in their entirety.

### TECHNICAL FIELD

The present technology relates to protein-fortified foods, including protein-fortified nutrition bars.

### BACKGROUND

Nutrition bars are a class of food products that offer a convenient and appealing way for someone to satisfy a portion of their daily calorie requirements. They are increasingly popular with busy consumers pressed for time and those looking for a fast between-meal snack. They are also popular with athletes who want a quick increase in calories and nutrients during periods of peak physical exertion.

There is increasing demand for nutrition bars with lower fat and sugar content relative to the protein content. Food manufacturers are addressing this demand by fortifying their nutrition bars with additional protein from both plant and animal sources. However, the increased protein content poses several challenges in making and storing the bars, including making bars with appealing taste, texture, and other organoleptic qualities, as well as producing bars with a commercially practical shelf life. These and other challenges are addressed by the present technology.

### SUMMARY

Embodiments of the present technology include protein-containing foods. The foods include a protein blend that includes one or more milk proteins. The protein blend includes less than or about 1500 mg % calcium.

In additional embodiments, the protein blend in the protein-containing foods includes less than or about 300 mg % calcium. In further embodiments, the protein blend includes less than 5 wt. % lactose. In yet additional embodiments, the one or more milk proteins include particle size-controlled milk proteins. In still further embodiments, the protein blend is characterized by a pH of less than or about 6. In more embodiments, the one or more milk proteins are selected from the group consisting of whey protein and casein protein. In yet more embodiments, the one or more milk proteins include greater than or about 25 wt. % glycomacropeptide. In still yet more embodiments, the one or more milk proteins include less than or about 12 wt. % glycomacropeptide. In additional embodiments, the whey protein is selected from the group consisting of whey protein isolate, whey protein concentrate, native whey protein, whey protein phospholipid concentrate, demineralized whey protein, glycomacropeptide, and low-pH whey protein. In further embodiments, the whey protein is selected from the group consisting of a native whey protein and a particle size-controlled whey protein. In yet additional embodiments, the casein protein is selected from the group consisting of acid casein, micellar casein, sodium caseinate, potassium caseinate, rennet casein, milk protein concentrate, and milk protein isolate. In still further embodiments, the casein protein is selected from the group consisting of a native casein protein and a particle size-controlled casein protein. In still more embodiments, the protein-containing foods include a high-protein nutrition bar.

Embodiments of the present technology also include food products with increased shelf stability. The food products include a protein blend that includes one or more milk proteins, where the protein blend includes less than or about 5 wt. % lactose. The food products are characterized by a total protein content of greater than or about 15 wt. %.

In additional embodiments, the protein blend includes less than or about 1500 mg % calcium. In further embodiments, the one or more milk proteins include particle size-controlled milk proteins. In yet additional embodiments, the protein blend is characterized by a pH of less than or about 6. In still further embodiments, the one or more milk proteins include at least one whey protein. In more embodiments, the at least one whey protein includes whey protein isolate. In yet more embodiments, the one or more milk proteins include at least one casein protein. In additional embodiments, the at least one casein protein includes micellar casein. In further embodiments, the one or more milk proteins include at least one casein or whey protein and at least one glycomacropeptide.

Embodiments of the present technology further include protein-containing foods that have a protein blend that includes one or more milk proteins. The protein blend includes less than or about 1500 mg. % calcium and less than or about 5 wt. % lactose. The one or more milk proteins include particle size-controlled proteins.

Embodiments of the present technology still further include methods of making a food product. The methods include combining a protein blend with additional ingredients to form a food mixture. The food mixture is treated to form the food product. The food product includes a total protein content of greater than or about 15 wt. %, and the protein blend includes less than or about 1500 mg % calcium.

In additional embodiments, the treatment of the food mixture to form the food product includes at least one of heating, forming, and pressing the food mixture into the food product. In still additional embodiments, the protein blend includes one or more milk proteins. In further embodiments, the one or more milk proteins are selected from the group consisting of whey protein concentrate, whey protein isolate, native whey protein, demineralized whey protein, glycomacropeptide, and low-pH whey protein. In further embodiments, the one or more milk proteins are selected from the group consisting of acid casein, micellar casein, rennet casein, sodium caseinate, potassium caseinate, milk protein concentrate, and milk protein isolate. In yet additional embodiments, the one or more milk proteins are selected from the group consisting of native milk proteins and particle size-controlled milk proteins. In still further embodiments, the one or more milk proteins include greater than or about 60 wt. % particle size-controlled milk proteins. In more embodiments, the protein blend includes less than or about 2 wt. % lactose. In still more embodiments, the protein blend is characterized by a pH of less than or about 6. In additional embodiments, the food product is a high-protein nutrition bar.

Embodiments of the present technology include foods such as nutrition bars with increased shelf stability compared to conventional nutrition bars made with conventional protein blends. The protein blends included in the present protein-fortified foods include a combination of ingredients and characteristics that reduce the rate of reactions that cause the food to become stale The present protein blends have one or more ingredients and characteristics including a reduced calcium content, a reduced lactose content, a reduced pH, particle sized-controlled milk proteins, and increased levels of glycomacropeptide, among other ingredients and characteristics, that allow a high-protein food product such as nutrition bar to have increased shelf stability. These and other attributes of the food product are achieved even when the protein blends are incorporated into the food product at levels of total protein that are greater than or about 15 wt. % of the product.

### DETAILED DESCRIPTION

Protein-fortified nutrition bars add proteins from various sources to increase the protein content of the bars relative to sugars, fats, and other ingredients. A popular source of added proteins are mammalian milk proteins, such as bovine milk proteins. In some instances, the milk proteins are sourced from the byproducts of dairy foods like cheese and yogurt. These milk byproduct sources are more concentrated in whey proteins and glycomacropeptides that are separated from the casein proteins incorporated into the dairy food such as cheese. In other instances, the milk proteins are sourced directly from the milk and are more concentrated in casein proteins, including micellar casein. The milk proteins are combined with other ingredients and formed into the nutrition bar.

The milk proteins added to the nutrition bar are accompanied to varying degrees by the sugars, fats, and minerals, also present in the native milk. In many instances, at least some of the milk fats are separated from the milk proteins to make them easier to form into a dry powder. In additional instances, at least some of the milk sugars are removed. The more the milk proteins are refined by removing other macronutrients, the more they cost to produce.

Many conventional methods of making a nutrition bar include adding relatively unrefined milk proteins to the bar's other ingredients to control costs. Unfortunately, as greater quantities of milk proteins are incorporated into the nutrition bar some of their undesirable attributes can reduce the quality of the nutrition bar. One of these undesirable attributes is the tendency of the milk proteins to harden and toughen the nutrition bar at a faster rate than a less protein-fortified bar. The faster hardening and toughening makes the nutrition bar go stale in a shorter period of time, which lowers the bar's shelf stability and shortens its shelf life.

The present technology addresses these and other problems with new formulations of single proteins and protein blends that make a protein-fortified food go stale at a significantly reduced rate. In embodiments, the protein and protein blends include milk proteins such as whey proteins, casein proteins, and glycomacropeptides, with significantly reduced amounts of at least one additional compound that can lower the shelf stability of foods made with the protein or protein blend. In further embodiments, the at least one additional compound includes calcium and lactose. In additional embodiments, the protein and protein blends (hereinafter protein blends) are characterized by a reduced pH, which has also been found to increase shelf stability of foods made with the protein blend. In more embodiments, the protein blends may include one or more particle size-controlled milk protein, such as a microparticulated whey protein, that have also been found to increase shelf stability of foods made with the blend. In embodiments, casein proteins may include acid casein, micellar casein, sodium caseinate, potassium caseinate, rennet casein, milk protein concentrate, and milk protein isolate, as well as combinations thereof. In embodiments, the whey protein may include whey protein isolate, whey protein concentrate, native whey protein, whey protein phospholipid concentrate, demineralized whey protein, glycomacropeptide, and low-pH whey protein, as well as combinations thereof.

Embodiments of the present technology include food products made with the present protein blends. In embodiments, the protein blend may be incorporated into the food product at a weight percentage of the total weight of the food product that is greater than or about 10 wt. %, greater than or about 11 wt. %, greater than or about 12 wt. %, greater than or about 13 wt. %, greater than or about 14 wt. %, greater than or about 15 wt. %, greater than or about 16 wt. %, greater than or about 17 wt. %, greater than or about 18 wt. %, greater than or about 19 wt. %, greater than or about 20 wt. %, greater than or about 21 wt. %, greater than or about 22 wt. % greater than or about 23 wt. %, greater than or about 24 wt. %, greater than or about 25 wt. %, or more. In additional embodiments, the incorporation of the protein blend in the food product gives the food product a total protein level of greater than or about 10 wt. %, greater than or about 12.5 wt. %, greater than or about 15 wt. %, greater than or about 16 wt. %, greater than or about 17 wt. %, greater than or about 18 wt. %, greater than or about 19 wt. %, greater than or about 20 wt. %, or more.

In additional embodiments, the protein blend may have a reduced amount of calcium compared to conventional protein blends that do not demineralize the proteins sourced from milk and milk byproducts like cheese and yogurt whey. It has been found that a reduced amount of calcium in the protein blend slows the rate of reactions in the milk proteins that can cause the food product to have a reduced shelf life. In further embodiments, the milk protein blend may be characterized by a calcium level of less than or about 1500 mg %, less than or about 1250 mg %, less than or about 1000 mg %, less than or about 750 mg %, less than or about 500 mg %, less than or about 400 mg %, less than or about 300 mg %, less than or about 200 mg %, less than or about 100 mg %, or less.

In further embodiments, the protein blend may have a reduce amount of lactose compared to conventional protein blends sourced from milk proteins. It has been found that a reduced amount of lactose in the protein blend slows the rate of reactions in the milk proteins that can cause the food product to have a reduced shelf life. In more embodiments, the milk protein blend may be characterized by a lactose amount of less than or about 5 wt. %, less than or about 4 wt. %, less than or about 3 wt. %, less than or about 2 wt. %, less than or about 1.75 wt. %, less than or about 1.5 wt. %, less than or about 1.25 wt. %, less than or about 1 wt. %, less than or about 0.75 wt. %, less than or about 0.5 wt. %, or less.

In more embodiments, the protein blend may be characterized by a lower pH than conventional protein blends sourced from milk proteins. It has been found that the lower pH of the protein blend slows the rate of reactions in the milk proteins that can cause the food product to have a reduced shelf life. In embodiments, the protein blend may be characterized by a pH of less than or about 6, less than or about 5.9, less than or about 5.8, less than or about 5.7, less than or about 5.6, less than or about 5.5, less than or about 5.4, less than or about 5.3, less than or about 5.2, less than or about 5.1, less than or about 5, or less.

In further embodiments, the protein blend may include one or more particle size-controlled proteins. In still further embodiments, the particle size-controlled proteins may include particle size-controlled whey proteins. In yet further embodiments, the particle size-controlled whey proteins may be formed by heat denaturizing and shearing the whey proteins. In additional embodiments, the particle size-controlled proteins may be characterized by a mean particle size of less than or about 20 μm, less than or about 15 μm, less than or about 10 μm, less than or about 5 μm, less than or about 4 μm, less than or about 3 μm, less than or about 2 μm, less than or about 1 μm, less than or about 0.5 μm, less than or about 0.1 μm, or less. It has been found that protein blends that include particle size-controlled proteins have reduced rates of reactions that can cause the food product to have a reduced shelf life. In yet more embodiments, the protein blend may be characterized by an amount of particle size-controlled proteins, as a weight percentage of total protein, that is greater than or about 25 wt. %, greater than or about 30 wt. %, greater than or about 35 wt. %, greater than or about 40 wt. %, greater than or about 45 wt. %, greater than or about 50 wt. %, greater than or about 60 wt. %, greater than or about 70 wt. %, greater than or about 80 wt. %, greater than or about 90 wt. %, greater than or about 95 wt. %, greater than or about 99 wt. %, or more.

In more embodiments, the protein blend may include glycomacropeptides. In embodiments, the glycomacropeptides may be sourced from a milk byproduct generated by an enzymatic coagulation of milk proteins in, for example, a cheesemaking process. It has been found that protein blends that include amounts of glycomacropeptides that are higher than the amounts of glycomacropeptides found in conventional protein blends have reduced rates of reactions that can cause a food product incorporating the protein blend to have a reduced shelf life. In additional embodiments, the protein blend may be characterized by an amount of glycomacropeptides, as a weight percentage of total protein, that is greater than or about 10 wt. %, greater than or about 15 wt. %, greater than or about 20 wt. %, greater than or about 25 wt. %, greater than or about 30 wt. %, greater than or about 35 wt. %, greater than or about 40 wt. %, greater than or about 45 wt. %, greater than or about 50 wt. %, or more.

Embodiments of the present technology also include food products made with the above-described protein blends that can increase the shelf stability of the food product. In more embodiments, the food product may include additional macronutrients, such as carbohydrates and lipids (e.g., fats and oils). In embodiments, the food product may include a weight percentage of total carbohydrates that is less than or about 85 wt. %, less than or about 80 wt. %, less than or about 75 wt. %, less than or about 70 wt. %, less than or about 65 wt. %, less than or about 60 wt. %, less than or about 55 wt. %, less than or about 50 wt. %, less than or about 45 wt. %, less than or about 40 wt. %, less than or about 35 wt. %, less than or about 30 wt. %, less than or about 25 wt. %, or less. In additional embodiments, the food product may include a weight percentage of total lipids that is less than or about 25 wt. %, less than or about 20 wt. %, less than or about 15 wt. %, less than or about 10 wt. %, less than or about 5 wt. %, less than or about 2.5 wt. %, less than or about 1 wt. %, or less.

In further embodiments, the carbohydrates present in the food product may include one or more monosaccharides and polysaccharides. In still further embodiments, the carbohydrates may include glucose, sucrose, fructose, lactose, honey, molasses, maple syrup, fruit juice concentrate, brown sugar, agave nectar, and high-fructose corn syrup, among other carbohydrates. In additional embodiments, the food product may include polysaccharides such as starches, gums, flours, dextrins, and maltodextrins, among other polysaccharides. In still additional embodiments, the carbohydrates may include starches and flours of corn, potato, rice, wheat, barley, soy, and sorghum, among other plants.

In additional embodiments, the lipids present in the food product may include one or more of animal lipids and plant lipids. In further embodiments, the animal lipids may include fats from milk products. In yet more embodiments, the plant lipids may include vegetable oils such as palm oil, palm kernel oil, cottonseed oil, soybean oil, corn oil, soybean oil, coconut oil, olive oil, peanut oil, sesame oil, sunflower oil, safflower oil, rapeseed oil, and canola oil, among other types of vegetable oils.

In further embodiments of the present technology, the food products may include one or more additional ingredients that are in addition to the macronutrients. In embodiments, the weight percentage of the food product taken by these one or more additional ingredients may be characterized as less than or about 50 wt. %, less than or about 40 wt. %, less than or about 30 wt. %, less than or about 25 wt. %, less than or about 20 wt. %, less than or about 15 wt. %, less than or about 10 wt. %, less than or about 9 wt. %, less than or about 8 wt. %, less than or about 7 wt. %, less than or about 6 wt. %, less than or about 5 wt. %, less than or about 4 wt. %, less than or about 3 wt. %, less than or about 2 wt. %, less than or about 1 wt. %, or less. In further embodiments, these additional ingredients may include sweeteners, flavoring agents, vitamins, minerals, amino acids, water, soluble fiber, antioxidants, and polyphenols, among other additional ingredients.

In more embodiments, the food product may include one or more sweeteners and flavoring agents. In embodiments, the sweetener may include one or more sugar alcohols such as arabitol, erythritol, maltitol, mannitol, lactitol, sorbitol, isomalt, and xylitol. In further embodiments, the one or more sweeteners may include aspartame, acesulfame potassium, neotame, saccharin, sucralose, advantame, stevia, monk fruit extract, tagatose, and trehalose, among other sweeteners. In still further embodiments, the flavoring agents may include caramel flavoring agents, chocolate flavoring agents (e.g., cocoa powder), vanilla flavoring agents, coffee flavoring agents, fruit flavoring agents, and flavoring agents, and spice flavoring agents, among other flavoring agents.

In further embodiments, the food product may be additionally fortified with one or more vitamins and/or minerals. In embodiments, the one or more vitamins may include vitamin A, vitamin C, vitamin D, vitamin E, vitamin K, and one or more B vitamins, among other vitamins. In further embodiments, the one or more B vitamins may include biotin, folic acid, niacin, niacinamide, pantothenate, pyridoxine hydrochloride, riboflavin, and thiamin hydrochloride, among other B vitamins. In yet additional embodiments, the one or more minerals may include bromine, chromium, copper, iodine, iron, magnesium, manganese, phosphates, phosphorus, potassium, selenium, sodium, sulfur, and zinc.

In additional embodiments, the food product may be further fortified with one or more amino acids such as arginine, histidine, isoleucine, leucine, lysine, methionine, phenylalanine, threonine, tryptophan, valine, alanine, aspartic acid, glutamic acid, glutamine, glycine, serine, tyrosine, creatine, among other amino acids. In yet additional embodiments, the food product may include phytochemicals, sterols, lycopine, herbal compounds such as ginseng, guarana, yerba mate, antioxidants, essential oils, and polyphenols, among other added compounds.

In still more embodiments, the food product may further include water as a significant weight percentage component in addition to the macronutrients. In embodiments, the food product may be characterized by a moisture content, as a weight percentage of the total weight of the food product, of less than or about 15 wt. %, less than or about 14 wt. %, less than or about 13 wt. %, less than or about 12 wt. %, less than or about 11 wt. %, less than or about 10 wt. %, less than or about 9 wt. %, less than or about 8 wt. %, less than or about 7 wt. %, less than or about 6 wt. %, less than or about 5 wt. %, or less.

In yet further embodiments, the food product may also include fiber, such as soluble fiber. In embodiments, the fiber can slow the rate of digestion of the food product to provide more time for the absorption of protein and other nutrients from the product. In additional embodiments, the food product may be characterized by a weight percentage of soluble fiber of greater than or about 0.5 wt. %, greater than or about 1 wt. %, greater than or about 2 wt. %, greater than or about 3 wt. %, greater than or about 4 wt. %, greater than or about 5 wt. %, or more.

In embodiments, the food product may be a protein-fortified nutrition bar. In additional embodiments, the protein-fortified nutrition bar may be characterized by a total weight of greater than or about 20 grams, greater than or about 30 grams, greater than or about 40 grams, greater than or about 50 grams, greater than or about 60 grams, greater than or about 70 grams, greater than or about 80 grams, greater than or about 90 grams, greater than or about 100 grams, or more. In yet more embodiments, the protein-fortified nutrition bar may be characterized by a caloric content (measured in food calories) of greater than or about 150 calories, greater than or about 160 calories, greater than or about 170 calories, greater than or about 180 calories, greater than or about 190 calories, greater than or about 200 calories, greater than or about 210 calories, greater than or about 220 calories, greater than or about 230 calories, greater than or about 240 calories, greater than or about 250 calories, greater than or about 260 calories, greater than or about 270 calories, greater than or about 280 calories, greater than or about 290 calories, greater than or about 300 calories, or more.

In further embodiments, the protein-fortified nutrition bars may include a variety of grain sizes. In still further embodiments, the average grain size in the nutrition bar effects the texture and mouthfeel, among other organoleptic qualities, of the bar. Larger average grain sizes make a nutrition bar with a more grainy, less homogeneous texture and mouthfeel, while smaller average grain sizes make a bar with a smoother, more homogenous texture and mouthfeel. In embodiments, a more grainy nutrition bar may be characterized by an average grain size of greater than or about 0.1 mm, greater than or about 0.25 mm, greater than or about 0.5 mm, greater than or about 0.75 mm, greater than or about 1 mm, greater than or about 1.25 mm, greater than or about 1.5 mm, greater than or about 1.75 mm, greater than or about 2 mm, or more. In additional embodiments, a less grainy, more homogeneous nutrition bar may be characterized by an average grain size of less than 0.1 mm, less than or about 0.05 mm, less than or about 0.025 mm, less than or about 0.01 mm, or less.

In additional embodiments, the protein-fortified nutrition bars may include one or more ingredients such as grains, cereals, nuts, fruit pieces, seeds, and chocolate, among other ingredients. In further embodiments, the protein-fortified nutrition bars may include one or more ingredients such as wheat, amaranth, barley, oats, rye, soy, buckwheat, fennel, sesame seeds, millet, triticale, flaxseeds, poppy seeds, caraway seeds, peanuts, almonds, hazelnuts, cashews, walnuts, pecans, Brazil nuts, pine nuts, vanilla bean, dehydrated fruits such as strawberries, blueberries, raspberries, apples, peaches, pears, pineapple, and cherries, among other dehydrated fruits, food chips such as chocolate chips, white chocolate chips, peanut butter chips, butterscotch chips, among other food chips.

Embodiments of the present technology include protein blends that increase the shelf stability of food products that include the protein blends as a protein fortifier. In embodiments, the increase in the shelf stability may be characterized by an increase in the shelf life of the food product compared to a conventional food product with the same weight percentage of protein that lacks the protein blend. In additional embodiments, a food product that includes one of the present protein blends may be characterized by an increased shelf life of greater than or about 10%, greater than or about 25%, greater than or about 50%, greater than or about 75%, greater than or about 100%, or more, compared to the shelf life of a conventional food product with the same weight percentage of protein that lacks the protein blend.

In the preceding description, for the purposes of explanation, numerous details have been set forth in order to provide an understanding of various embodiments of the present technology. It will be apparent to one skilled in the art, however, that certain embodiments may be practiced without some of these details, or with additional details. For example, other food products besides nutrition bars may benefit from the protein blends described and may also be used with the present technology.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a ingredient” includes a plurality of such ingredients, and reference to “the protein” includes reference to one or more proteins and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed:

1. A protein-containing food comprising:
a protein blend that includes one or more milk proteins, wherein the protein blend comprises less than or about 1500 mg % calcium.

2. The protein-containing food of claim 1, wherein the protein blend comprises less than or about 300 mg % calcium.

3. The protein-containing food of claim 1, wherein the protein blend comprises less than or about 5 wt. % lactose.

4. The protein-containing food of claim 1, wherein the one or more milk proteins comprise particle size-controlled milk proteins.

5. The protein-containing food of claim 1, wherein the protein blend is characterized by a pH of less than or about 6.

6. The protein-containing food of claim 1, wherein the one or more milk proteins are selected from the group consisting of whey protein and casein protein.

7. The protein-containing food of claim 1, wherein the one or more milk proteins comprise greater than or about 25 wt. % glycomacropeptide as a percentage of total protein.

8. The protein-containing food of claim 1, wherein the one or more milk proteins comprise less than or about 12 wt. % glycomacropeptide as a percentage of total protein.

9. The protein-containing food of claim 6, wherein the whey protein is selected from the group consisting of whey protein isolate, whey protein concentrate, native whey protein, whey protein phospholipid concentrate, demineralized whey protein, glycomacropeptide, and low-pH whey protein.

10. The protein-containing food of claim 6, wherein the whey protein is selected from the group consisting of a native whey protein and a particle size-controlled whey protein.

11. The protein-containing food of claim 6, wherein the casein protein is selected from the group consisting of acid casein, micellar casein, rennet casein, sodium caseinate, and potassium caseinate.

12. The protein-containing food of claim 6, wherein the casein protein is selected from the group consisting of a native casein protein and a particle size-controlled casein protein.

13. The protein-containing food of claim 1, wherein the protein-containing food comprises a high-protein nutrition bar.

14. A food product with increased shelf stability, the food product comprising:
a protein blend that includes one or more milk proteins, wherein the protein blend comprises less than or about 5 wt. % lactose, and
wherein the food product is characterized by a total protein content of greater than or about 15 wt. %.

15. The food product of claim 14, wherein the protein blend comprises less than or about 1500 mg % calcium.

16. The food product of claim 14, wherein the one or more milk proteins comprise particle size-controlled milk proteins.

17. The food product of claim 14, wherein the protein blend is characterized by a pH of less than or about 6.

18. The food product of claim 14, wherein the one or more milk proteins comprises at least one whey protein.

19. The food product of claim 18, wherein the at least one whey protein comprises whey protein isolate.

20. The food product of claim 14, wherein the one or more milk proteins comprises at least one casein protein.

21. The food product of claim 20, wherein the at least one casein protein comprises micellar casein.

22. The food product of claim 14, wherein the one or more milk proteins comprises at least one casein or whey protein and at least one glycomacropeptide.

23. A protein-containing food comprising:
a protein blend comprising one or more milk proteins,
wherein the protein blend comprises less than or about 1500 mg. % calcium and less than or about 5 wt. % lactose, and
wherein the one or more milk proteins comprise particle size-controlled proteins.

24. A method of making a food product, the method comprising:
combining a protein blend with additional ingredients to form a food mixture; and
treating the food mixture to form the food product,
wherein the food product comprises a total protein content of greater than or about 15 wt. %, and wherein the protein blend comprises less than or about 1500 mg % calcium.

25. The method of claim 24, wherein treating the food mixture to form the food product comprises at least one of heating, forming, and pressing the food mixture.

26. The method of claim 24, wherein the protein blend comprises one or more milk proteins.

27. The method of claim 26, wherein the one or more milk proteins are selected from the group consisting of whey protein concentrate, whey protein isolate, native whey protein, demineralized whey protein, glycomacropeptide, and low-pH whey protein.

28. The method of claim 26, wherein the one or more milk proteins are selected from the group consisting of acid casein, micellar casein, rennet casein, sodium caseinate, potassium caseinate, milk protein concentrate, and milk protein isolate.

29. The method of claim 26, wherein the one or more milk proteins are selected from the group consisting of native milk proteins and particle size-controlled milk proteins.

30. The method of claim 26, wherein the one or more milk proteins comprise greater than or about 60 wt. % particle size-controlled milk proteins.

31. The method of claim 24, wherein the protein blend comprises less than or about 5 wt. % lactose.

32. The method of claim 24, wherein the protein blend is characterized by a pH of less than or about 6.

33. The method of claim 24, wherein the food product is a high-protein nutrition bar.
